(19) United States
(12) Patent Application Publication
(10) Pub. No.: US 2018/0075389 A1
(43) Pub. Date: Mar. 15, 2018

(54) SYSTEM AND METHOD FOR IMPROVING ORGANIZATION PERFORMANCE USING SIPOC TO DEFINE THE BALANCED SCORECARD LEARNING AND GROWTH PERSPECTIVE STRATEGIC OBJECTIVES FOR STRATEGIC AND KEY INTERNAL PROCESSES BASED ON A BUSINESS INTELLIGENCE SERVER

(71) Applicant: Mohammed Ali ALGHAMDI, Orlando, FL (US)

(72) Inventor: Mohammed Ali ALGHAMDI, Orlando, FL (US)

(21) Appl. No.: 15/261,228

(22) Filed: Sep. 9, 2016

(51) Int. Cl. G06Q 10/06; G06F 17/30

(52) U.S. Cl. CPC G06Q 10/06393; G06F 17/30321

(57) ABSTRACT

A system to support business performance, comprising a computer with one or more processors; a business intelligence server running on the computer, wherein the business intelligence server operates to take inputs from different data sources; a scorecard application associated with the business intelligence server; and a process improvement application associated with the business intelligence server, wherein the business intelligence server operates to define an internal data structure that holds a plurality of strategy components and one or more key performance indicators, populate each strategy component in the internal data structure based on the inputs from the different data sources, analyze the one or more key performance indicators via the process improvement application to identify strategic and key internal processes requirements, and output the identified strategic and key internal processes requirements to the scorecard application.

### BACKGROUND

### Grant of Non-Exclusive Right

This application was prepared with financial support from the Saudia Arabian Cultural Mission, and in consideration therefore the present inventor(s) has granted The Kingdom of Saudi Arabia a non-exclusive right to practice the present invention.

### Description of the Related Art

The “background” description provided herein is for the purpose of generally presenting the context of the disclosure. Work of the presently named inventor, to the extent it is described in this background section, as well as aspects of the description which may not otherwise qualify as prior art at the time of filing, are neither expressly or impliedly admitted as prior art against the present invention.

In the context of computer software, and particularly computer databases, the term “data warehouse” is generally used to refer to a unified data repository for all customer-centric data. A data warehouse environment tends to be quite large. The data stored in the data warehouse can be cleaned, transformed, and catalogued. Such data can be used by business professionals for performing business related operations, such as data mining, online analytical processing, decision support, process improvement methods, e.g., suppliers, inputs, process, outputs, and customers (SIPOC) process analysis methodology. Typically, a data warehouse can be associated with extract, transform, and load (ETL) processes and business intelligence tools. The ETL processes are capable of extracting data from source systems and bringing the data into a data warehouse. The business intelligence tools are designed to report, analyze and present data stored in the data warehouse. This is the general area that embodiments of the present disclosure are intended to address.

### SUMMARY

Embodiments include a system to support business performance, including a computer with one or more processors and a business intelligence server running on the computer, wherein the business intelligence server operates to take inputs from different data sources. The system also includes a scorecard application such as a balanced scorecard (BSC) methodology and a process improvement application such as a supplier, input, process, output, and customer (SIPOC) process analysis methodology. The scorecard application and the process improvement application can be associated with the business intelligence server to be executed via software instructions. For example, the business intelligence server is articulated through an internal data structure that holds a plurality of strategy components and one or more key performance indicators.

In other words, the internal data structure may include, directed courses of actions to achieve an intended set of goals, specific maneuvers intended to outwit a competitor, and/or data providing brands, products, or companies within the market, based on the conceptual framework of consumers or other stakeholders.

The business intelligence server also operates to populate each strategy component in the internal data structure based on the inputs from the different data sources. The business intelligence server further operates to analyze the one or more key performance indicators via the process improvement application to identify strategic and key internal processes requirements. The business intelligence server also operates to output the identified strategic and key internal processes requirements to the scorecard application.

Embodiments also include a method, including associating a scorecard application with a business intelligence server that operates to take from different data sources. The method also includes associating a process improvement application with the business intelligence server. The method further includes allowing the scorecard application and the process improvement application associated with the business intelligence server to define an internal data structure that holds a plurality of strategy components and one or more key performance indicators. The method also includes allowing the scorecard application and the process improvement application associated with the business intelligence server to populate each strategy component in the internal data structure based on the inputs from the different data sources. The method further includes allowing the scorecard application and the process improvement application associated with the business intelligence server to analyze the one or more key performance indicators via the process improvement application to identify strategic and key internal processes requirements. The method also includes allowing the scorecard application and the process improvement application associated with the business intelligence server to output the identified strategic and key internal processes requirements to the scorecard application.

Embodiments further include a non-transitory computer-readable medium having instructions stored thereon that when executed in hardware, cause a system to associate a scorecard application with a business intelligence server that operates to take from different data sources. The non-transitory computer-readable medium when executed in hardware, also cause the system to associate a process improvement application with the business intelligence server. The non-transitory computer-readable medium when executed in hardware further cause the system to allow the scorecard application and the process improvement application associated with the business intelligence server to define an internal data structure that holds a plurality of strategy components and one or more key performance indicators. The non-transitory computer-readable medium when executed in hardware also cause the system to allow the scorecard application and the process improvement application associated with the business intelligence server to populate each strategy component in the internal data structure based on the inputs from the different data sources. The non-transitory computer-readable medium when executed in hardware further cause the system to allow the scorecard application and the process improvement application associated with the business intelligence server to analyze the one or more key performance indicators via the process improvement application to identify strategic and key internal processes requirements. The non-transitory computer-readable medium when executed in hardware also cause the system to allow the scorecard application and the process improvement application associated with the business intelligence server to output the identified strategic and key internal processes requirements to the scorecard application.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is an illustrative view of an example flow diagram of a balanced scorecard (BSC) methodology according to certain embodiments of the disclosure.

FIG. 2 is an illustrative view of an example of a supplier, input, process, output, and customer (SIPOC) process analysis methodology according to certain embodiments of the disclosure.

FIG. 3 is an illustrative view of a flow diagram of a balanced scorecard application combined with a SIPOC process analysis application according to certain embodiments of the disclosure.

FIG. 4 is an illustrative view of a network environment implementing a process optimization system for evaluating and improving processes implemented by an organization according to certain embodiments of the disclosure.

FIG. 5 is an example flow chart for supporting business strategy management using the balanced scorecard and SIPOC application according to certain embodiments of the disclosure.

FIG. 6 is an illustrative view of a block diagram of an exemplary process optimizer for implementing the process optimization system of FIG. 4 according to certain embodiments of the disclosure.

### DETAILED DESCRIPTION OF THE EMBODIMENTS

Referring now to the drawings, wherein like reference numerals designate identical or corresponding parts throughout the several views.

In today's competitive business environment, establishing strategic objectives and measures that secure and sustain a competitive position and achieve the financial objectives in the long run is essential for organizations. To achieve such objectives, a set of specific financial and nonfinancial strategies and measures must be carefully selected. The balanced scorecard (BSC) is a comprehensive management system that translates the organization's mission and vision into a set of strategies and measures linked by a cause and effect relationship. This comprehensive management system enables a senior leadership team to improve their strategic decision-making to reach high valued business results and breakthrough performance. The BSC consists of four perspectives, namely, customer, internal processes, financial, and learning and growth. The customer perspective indicates how to obtain the satisfaction of the customers; the internal processes perspective identifies strategic and key internal processes that the organization must excel at to increase customer satisfaction and achieve superior financial returns; and the financial perspective carries the shareholders perceptions.

The learning and growth perspective determines and communicates the capabilities, e.g., human, technology, and procedures, required to successfully, and effectively perform the strategic and key internal processes, increase the satisfaction of customers, reach better financial objectives, and ultimately increase the performance of the organization. It has been stated in the literature that enhanced financial results would be realized by the organization if the customers' desires are understood, strategic and key internal processes are defined, financial objectives are properly set, and capabilities required to execute and recover strategic and key internal processes are established. The learning and growth is seen as the least researched perspective in spite of its crucial role and potential impact on the performance and success of the organization.

A standard and robust method to the required objectives in the learning and growth perspective for the strategic and key internal processes is required to ultimately help organizations in obtaining better performance. The financial, customer, and internal-business-processes objectives on the BSC conventionally provide large discrepancies between the existing human and systems capabilities and what will be required to achieve breakthrough performance. To overcome these discrepancies, business must develop the employees' skills, information technology and systems, and adopting organizational procedures and routines. These objectives are developed in the learning and growth perspective of the BSC. Thus, there is a need to better utilize the learning and growth perspective of the BSC to analyze these objectives.

SIPOC is a six sigma process mapping and analysis method that stands for Supplier, Input, Process, Output, and Customer. The analysis of the targeted processes include the careful identification and articulation of the process suppliers, their inputs, the process under analysis which is triggered by the inputs, the output of the process, and the customers who will receive these outputs of the process; therefore covering and analyzing all aspects relevant to the process under study. SIPOC does not only provide the appropriate framework, mechanism, and mindset for existing and new processes analysis but it also allows organizations to appropriately articulate the needed capabilities or requirements for the process and its suppliers, inputs, outputs, and customers covering all possible segments of the process for successful process execution and increased internal and external customers and suppliers satisfaction. The prior art shows very little reflections on the SIPOC's capability to determine process requirements articulation.

Six sigma focuses on process, quality and the elimination of variations and defects from products. Six sigma prompts the question, what are the key factors affect the outcomes and what is the best method to increase the probability of a good outcome? What are the benefits of standardizing the process? In statistics, Six Sigma generally denotes a process that produces only 3.4 defective parts per million and has since come to symbolize any system that strives for and achieves near perfection.

Alternatively, lean six sigma is a comprehensive strategy for eliminating waste and increasing the flow of products. It separates “value adding” from “non-value adding” work, using well-known business and process-management tools. Lean six sigma combines these two related strategies, to deliver quality and efficiency.

The lean six sigma methodology is broken into five steps: (1) define the problem; (2) measure the current performance; (3) analyze opportunities to reduce waste or variation; (4) improve the process by implementing and testing process changes; and (5) continuously evaluate the improved process. In the first phase, the organization identifies an area for improvement, such as, an administrative process or production area where bottlenecks occur or areas where everything is a “mess.”

For example, in the banking world, relevant questions that could lead to the identification of a problematic process may include: How many hands touch a loan application and the related underwriting file before a loan is approved and funded? Do multiple employees gather and input the same information on a single account? Do the inefficiencies delay loan funding and the collection of loan fees and interest income? What's the process for documenting a commercial loan? Is loan servicing using the same criteria for security instruments and title endorsements on each commercial real estate loan? Is there a way to streamline the process for periodic reporting so loan officers spend more time generating business and administering loans than compiling data and preparing reports? Can we offer preferred or present customers a streamlined loan package to generate repeat business?

The prior art shows little to no research or practical efforts to build or set a standard model or a practice to define the balanced scorecard (BSC) learning and growth perspective strategic objectives specifically not in the manner described in this application. SIPOC and the BSC were never integrated in one framework that leverages the advantages of each for the crucial best of the whole integrated model as proposed here. Each of the BSC and the SIPOC has majorly been working independently in the strategic management and six sigma fields, respectively.

Certain embodiments represent the missing link to help an organization to scientifically derive the balanced scorecard (BSC) learning and growth strategic objectives through the proper determination of the specific capabilities needed for their strategic and key internal processes in order to be executed successfully, efficiently, and effectively in order to achieve increased customer satisfaction, improve financial results, and ultimately improve the organization's performance.

The SIPOC process analysis methodology discussed above may be the required missing link to help an organization to scientifically derive the BSC learning and growth strategic objectives through the proper determination of the specific capabilities needed for their strategic and key internal processes in order to be executed successfully, efficiently, and effectively in order to achieve increased customer satisfaction, improve financial results, and ultimately improve the organization's performance. The prior art indicates that the SIPOC method has been used primarily within the six sigma environment. The prior art also shows little to no research or practical efforts to build or set a standard model or a practice to define the BSC learning and growth perspective strategic objectives; specifically not such as the shown in certain embodiments of this disclosure.

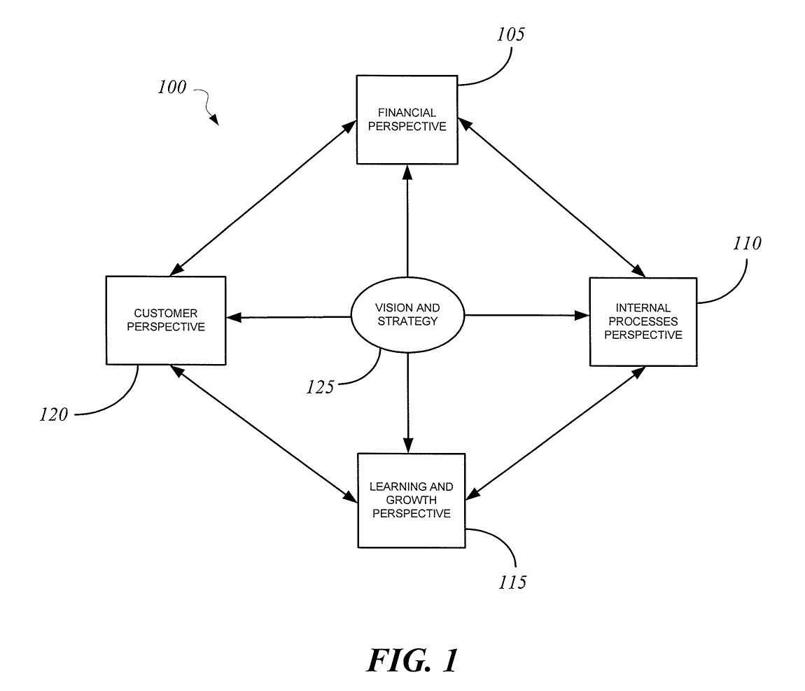

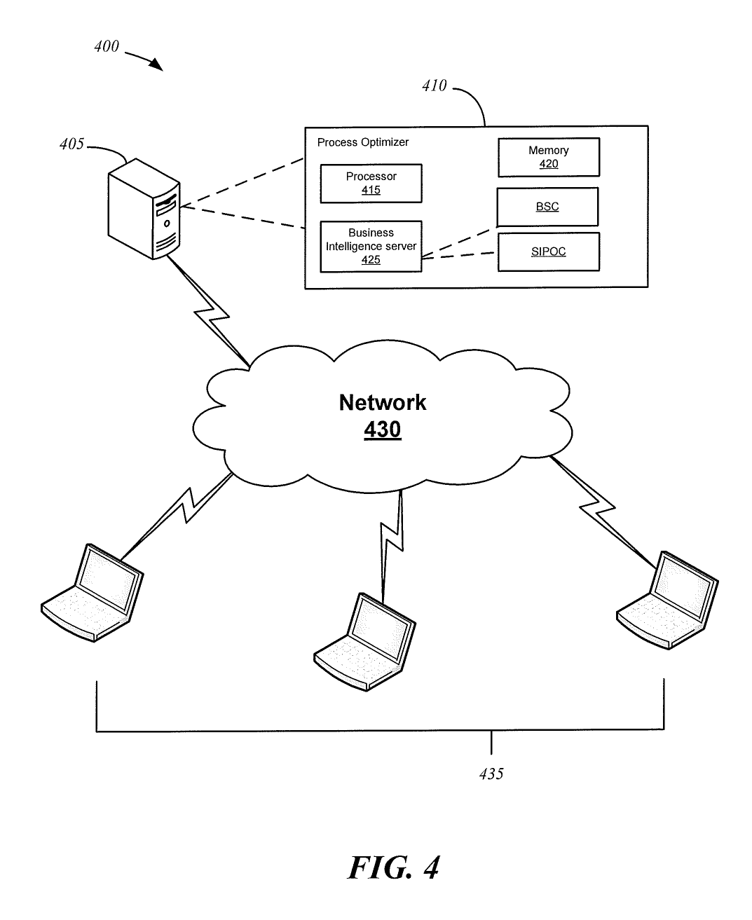

FIG. 1 is an illustrative view of an example flow diagram of a balanced scorecard (BSC) methodology 100 according to certain embodiments of the disclosure. In FIG. 1, the BSC 100 is a strategic performance management framework that has been designed to help an organization monitor its performance and manage the execution of its strategy component 125. As shown in FIG. 1, in its simplest form, the BSC 100 breaks performance monitoring into plural interconnected perspectives or components, such as, Financial perspective 105, Internal Processes perspective 110, Customer perspective 120, and Learning and Growth perspective 115. Each of these components includes its own objectives, targets, measures, and initiatives to be considered and populated, for example key performance indicators (KPIs), via various data sources (see FIG. 4 at 435). The Financial perspective 105 includes the financial objectives of an organization and allows managers to track financial success and shareholder value. The Customer perspective 120 includes the customer objectives such as customer satisfaction, market share goals as well as product and service attributes. The Internal Processes perspective 110 includes internal operational goals and outlines the strategic and key processes necessary to deliver the customer objectives. The Learning and Growth perspective 115 includes the intangible drivers of future success, such as human capital, organizational capital and information capital including skills, training, organization culture, leadership, systems, and databases.

The financial perspective 105, customer perspective 120, and internal processes perspective 110 on the BSC 100 conventionally suffer from large inconsistencies between the existing capabilities between the existing capabilities of human capabilities, procedures, and systems, and the requirements to achieve breakthrough performance. To overcome these inconsistencies, businesses will have to implement new objectives by diversifying employee skills, enhancing information technology (IT) and systems, and aligning organizational procedures and routines. These new objectives are articulated and implemented in the learning and growth perspective present in the BSC 100.

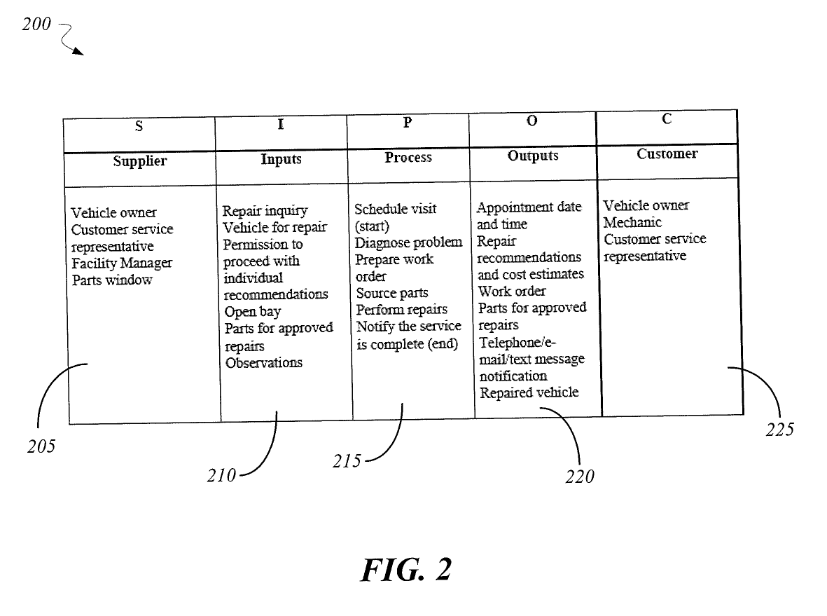

FIG. 2 is an illustrative view of an example of a supplier, input, process, output, and customer (SIPOC) process analysis methodology 200 according to certain embodiments of the disclosure. In FIG. 2, an example is shown of a process improvement of an organization, such as automobile repair. A SIPOC 200 is a tool may be utilized which summarizes the inputs and outputs of one or more processes in table form. In FIG. 2, for the automobile repair example, the suppliers 205 are the vehicle owner, the customer service representative, the facility manager, and the parts window. The inputs 210 are the repair inquiry, the vehicle for repair, the permission to proceed with individual recommendations, the open service bay, the parts for approved repairs, and the observations made. The process 215 must have a start and an end point. The process 215 includes the scheduling the visit, diagnosing the problem, preparing the work order, sourcing the needed parts, performing the repairs, and notifying the customer that service is completed. The outputs 220 are the appointment date and time, the repair recommendations and cost estimates, the work order, the parts for the approved repairs, the telephone/e-mail/text message notification to the customer providing updates, etc., and the repaired vehicle. The customer 225 is the vehicle owner, the mechanic, and the customer service representative in this example.

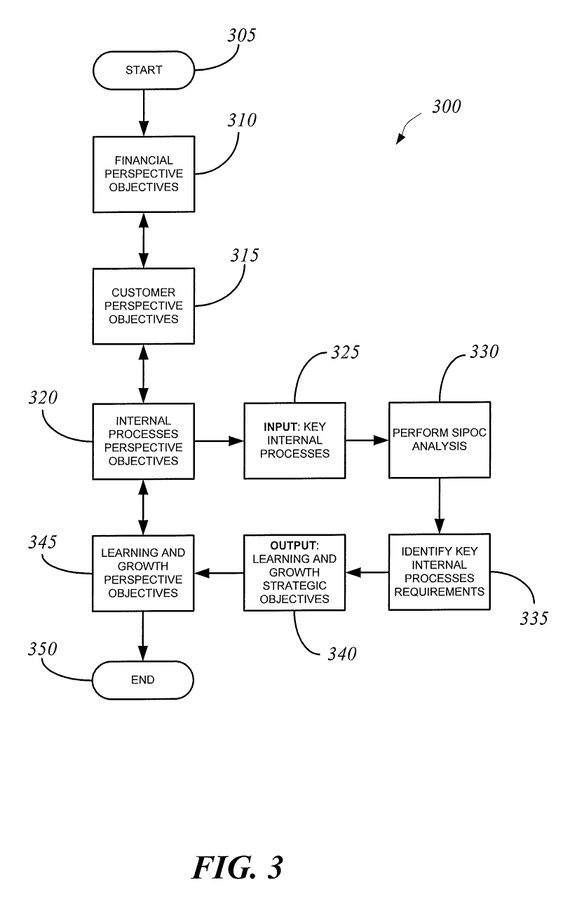

FIG. 3 is an illustrative view of a flow diagram 300 of a balanced scorecard application combined with a SIPOC process analysis application according to certain embodiments of the disclosure. In FIG. 3, the method 300 starts implementation at 305 of the BSC process. At 310, the financial perspective 105 is determined. For example, the financial concerns or criteria of the shareholders or account managers of an organization may be inputted. In other words, a financial module may be configured to process and accept metrics regarding financial data.

At 315, the customer perspective 120 is determined, for example, the needs and wants of the customer may be inputted. In other words, a customer module may be configured to process and accept metrics regarding customer surveys and comments. At 320, the internal processes perspective 110 is determined. For example, strategic and key internal processes increasing customer satisfaction and/or achieving superior financial returns may be inputted. In other words, an internal processes module may be configured to process and accept metrics regarding key customer feedback and key performance indicators (KPIs) for the organization's financial goals.

For example, these metrics may be customer satisfaction survey, percentage of returning customers, number of customers, level of returned products, product quality, stock values, profits, or a function thereof as expressed by the key performance indicators (KPIs).

At 325, strategic and key internal processes are determined. For example, the processed metrics found from the internal processes perspective 320 may be inputted. In other words, a strategic and key internal processes module may be configured to process and accept metrics resulting in regarding the inputs for a SIPOC 330 analysis. At 330, the SIPOC 330 analysis is applied and performed on the inputs received from the strategic and key internal process module 325. In other words, the SIPOC 330 analysis may include a module configured to receive supplier data for a user, input and process metrics from the strategic and key internal process module 325 and then the module may output strategic and key internal processes requirements to be identified based on specific customers or customer requirements.

Further, the module for SIPOC at 330 may be configured to determine the internal processes requirements articulation needed to obtain the output at 340. At 335, upon completion of the SIPOC 330 analysis, strategic and key internal processes requirements are identified based on metrics of specific customers or customer requirements resulting in improved customer satisfaction. For example, if the metrics indicate a low percentage of returning customers (e.g. lower than 50%), one of the identified strategic and key internal processes requirements may be a requirement to increase the quality of the products provided or on sale. Alternatively, if the number of customer is small, one of the identified strategic and key internal processes requirements may be a requirement to enhance the promotion of the products provided or on sale.

In other words, the strategic and key internal processes requirements 335 may include an identification module configured to process and accept these metrics in order to identify these requirements.

At 340, an output is generated including learning and growth strategic objectives. In other words, learning and growth strategic objectives may include a module configured to process and accept identified strategic and key internal processes requirements metrics at 335, such as high customer service and satisfaction metrics. At 345, the learning and growth perspective 115 is determined. For example, the human and technologic capabilities and procedures required to execute the strategic and key internal processes leading to an increase of customer satisfaction, financial efficiency, and ultimately increase the performance or the organization with respect to the strategic objectives is outputted. In other words, the learning and growth perspective may include a module configured to receive the learning and growth strategic objectives output 340 and incorporate this output into the learning and growth perspective 345.

At 350, the process ends implementation, resulting in a clarified and distinct learning and growth perspective 345 for the BSC 100. The result of the method 300 may be the closing of the gap between existing capabilities and future capabilities to achieve breakthrough performance goals. The SIPOC analysis 330 may be configured to provide strategic management for performance excellence and superiority via integration with the BSC learning and growth perspective strategic objectives 340. The resulting output at 340 provides learning and growth strategic objectives, such as, high customer service and satisfaction.

The modules discussed above may be implemented as part of a scorecard application in software and/or hardware such as in process optimizer 410 or business intelligence server 425 (see FIG. 4).

Upon execution, the method 300 may result in increased customer satisfaction that each organization strives to meet through the articulation of customers and their requirements via the SIPOC methodology. This novel method allows the proper determination of the specific capabilities needed for the strategic and key internal processes in order to be well, i.e. successfully, efficiently, and effectively, executed and increases customer satisfaction achieve increased customer satisfaction. Method 300 provides a scientific standard method to define the required capabilities (objectives) in the learning and growth perspective for the strategic and key internal processes needed to ultimately help organizations improve their performance. The financial perspective 105, customer perspective 120, and internal processes perspective 110 on the BSC 100 conventionally suffer from large inconsistencies between the existing capabilities between the existing capabilities of human capabilities, procedures, and systems, and the requirements to achieve breakthrough performance. To overcome these inconsistencies, businesses will have to implement new objectives by diversifying employee skills, enhancing information technology (IT) and systems, and aligning organizational procedures and routines. These new objectives are articulated and implemented in the learning and growth perspective present in the BSC 100. Thus, method 300 may save organizations time and money by combining the BSC and SIPOC methods in a novel manner to close these large gaps.

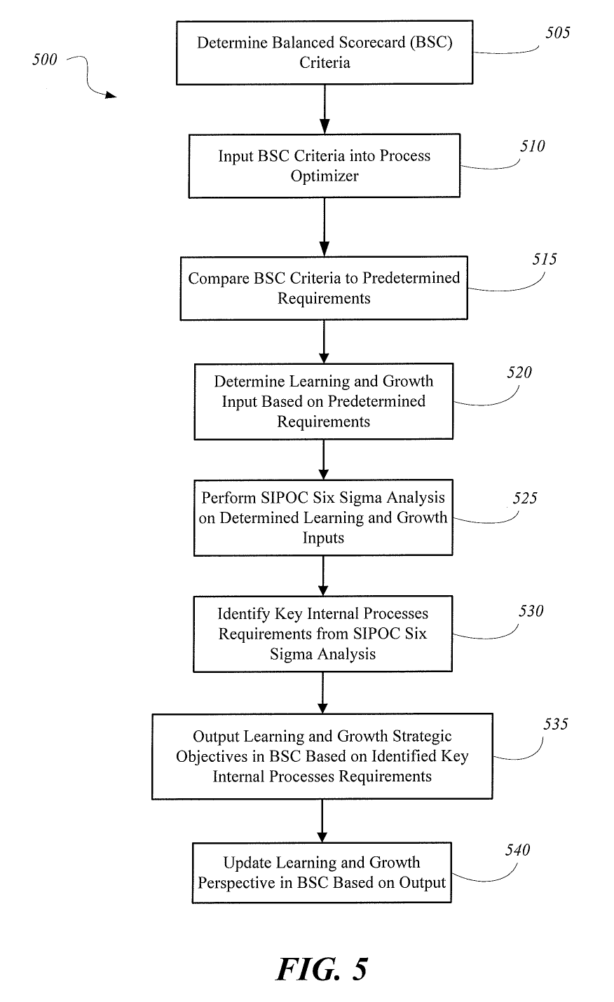

FIG. 4 is an illustrative view of a network environment 400 implementing a process optimizer 410 for evaluating and improving processes implemented by an organization according to certain embodiments of the disclosure. In FIG. 4, process optimizer 410 may be configured to compare and evaluate BSC with SIPOC analysis of strategic and key internal processes of various organizations. The process optimizer 410 is configured to enable comparison of BSC with SIPOC attributes and evaluation of available and generated data. Process optimizer 410 may be disposed in a computer server 405 or the like. Process optimizer 410 may include at least one processor 415, at least one memory 420, and a business intelligence server 425 configured to evaluate and compare BSC with SIPOC analysis of strategic and key internal processes of various organizations. All the steps for such an implementation are further described in FIG. 5 and paragraph [0049].

The network environment 400 includes the process optimizer 410 communicating through a network 430 with a plurality of client devices, for example, tablet computers, smartphones, laptop computers, and the like, hereinafter collectively referred to as client device(s) 435.

The network 430 may be a wireless network, wired network or a combination thereof. The network 430 can be implemented as one of the different types of networks, such as intranet, local area network (LAN), wide area network (WAN), the internet, and such. The network 430 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other.

The client device(s) 435 are configured to feed the required data to the process optimizer 410. The client device(s) 435 are also configured to receive results from the process optimizer 410. These client device(s) 435 may be located at several remote locations of different organizations to store data of elements like suppliers, inputs, etc., associated with different processes. The client device(s) 435 may also be associated with the process optimization system for data entry or for use by a process optimization system administrator, also referred to as a system manager.

In one implementation, the process optimizer 410 includes a business intelligence (BI) server 425. The BI server 425 may be configured to examine different BSC and SIPOCs to determine the key differentiating factors between examined BSC and SIPOCs and implement metrics to measure the degree of success of the organization or of particular activities in which the organization engages. For example, a plurality of metrics may be used to calculate the KPIs which provide a measure of the productivity and efficiency of the processes implemented by the organization.

The selection of the plurality of metrics constituting the KPIs may rely on various techniques to assess the present state of the business, and its key activities.

In one implementation, one of these techniques may rely on a management framework such as the BSC 100 and SIPOC. More precisely, the KPIs may include benchmark BSC and SIPOC and benchmark attributes. The BI server 425 may also be configured to compare attributes of BSC and SIPOCs of different organizations to the KPIs, such as, benchmark SIPOC and benchmark attributes.

Further, the BI server 425 may perform certain evaluation functions and also is configured to ascertain different attributes of improvement based on the results of any comparisons made by the BI server 425. To this end, the BI server 425 may also be configured to evaluate the ratings related to every attribute and determine the scores associated with every BSC and SIPOC. The process optimizer 410 and the client devices 435 can be implemented as any of a variety of computing devices, including, for example, servers, desktop PCs, notebooks or portable computers, workstations, mainframe computers, mobile computing devices, entertainment devices, and an internet appliances. The process optimizer 410 can implement different process optimization processes such as a BSC and SIPOC comparison process and a process evaluation process.

In one implementation, the BI server 425 calculates the rating of every attribute related to a process (e.g. customer satisfaction and product appreciation) based on certain KPIs (e.g. customer satisfaction survey, percentage of returning customers, and level of returned products). Alternatively, the BI server 425 is configured to evaluate rating score for BSC and SIPOCs.

For the purpose of process optimization, the process optimizer 410 collects the details of the suppliers, inputs, outputs and customers along with data of the elements like productivity, difficulty level, accuracy of the process, etc., for different organizations either through client device(s) 435 or from locally stored BSC and SIPOC repository, to implement a strategy performance management tool such as the BSC 100 and/or the SIPOCs 200 of these organizations (see FIGS. 1 and 2).

Every new element introduced forms a new entry in a BSC and SIPOC. In one implementation, the data required to develop a BSC and SIPOC is introduced to the process optimizer 410 through different client device(s) 435. Different organizations can also supply entries for the elements of a BSC and SIPOC through client devices such as client device(s) 435 to be used by the process optimizer 410. In another implementation, the data can be supplied to the process optimizer 410 by an administrator from any of the onsite located client devices such as client device(s) 435.

FIG. 5 is an example flow chart 500 for supporting business strategy management using the balanced scorecard (BSC) and SIPOC applications according to certain embodiments of the disclosure. In FIG. 5, flow chart 500 includes at 505, determining BSC criteria, such as, objectives, measures (KPIs), targets and/or initiatives for each of the categories of financial, customer, internal business processes, and learning and growth. At 510, inputting BSC criteria into process optimizer 410. At 510, comparing BSC criteria to predetermined requirements. At 520, determining learning and growth input based on predetermined requirement. At 525, performing a SIPOC six sigma analysis on the key processes that are related to the internal processes perspective. At 530, identifying strategic and key internal processes requirements from SIPOC six sigma analysis. At 535, outputting learning and growth strategic objectives are identified based on SIPOC analysis output of the strategic and key processes. At 540, updating the learning and growth perspective in the BSC based on the output received.

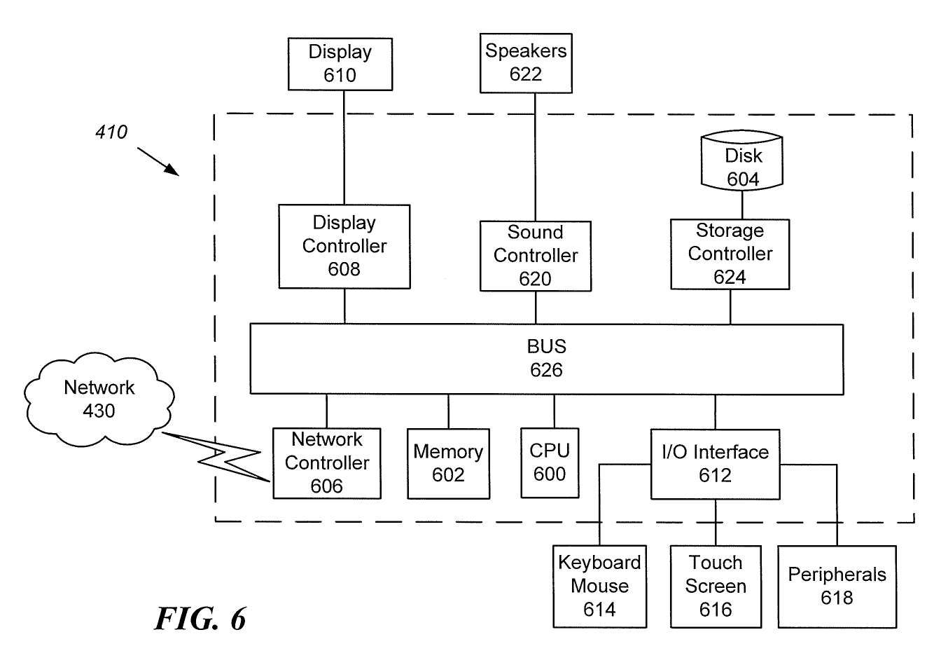

FIG. 6 is an illustrative view of a block diagram of an exemplary process optimizer 410 for implementing the process optimization system of FIG. 4 according to certain embodiments of the disclosure. In FIG. 6, a hardware description of the process optimizer 410 according to exemplary embodiments is described. In FIG. 6, the process optimizer 410 includes a CPU 600 which performs the processes described above/below. The process data and instructions may be stored in memory 602. These processes and instructions may also be stored on a storage medium disk 604 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the process optimizer 410 communicates, such as a server or computer.

Further, the claimed advancements may be provided as a utility application, background daemon, or component of an operating system, or combination thereof, executing in conjunction with CPU 600 and an operating system such as Microsoft Windows®, UNIX®, Solaris®, LINUX®, Apple® MAC-OS and other systems known to those skilled in the art.

The hardware elements in order to achieve the process optimizer 410 may be realized by various circuitry elements, known to those skilled in the art. For example, CPU 600 may be a Xeon® or Core® processor from Intel® of America or an Opteron® processor from AMD® of America, or may be other processor types that would be recognized by one of ordinary skill in the art. Alternatively, the CPU 600 may be implemented on an FPGA, ASIC, PLD or using discrete logic circuits, as one of ordinary skill in the art would recognize. Further, CPU 600 may be implemented as multiple processors cooperatively working in parallel to perform the instructions of the inventive processes described above.

The process optimizer 410 in FIG. 6 also includes a network controller 606, such as an Intel® Ethernet PRO® network interface card from Intel® Corporation of America, for interfacing with network 430. As can be appreciated, the network 430 can be a public network, such as the Internet, or a private network such as an LAN or WAN network, or any combination thereof and can also include PSTN or ISDN sub-networks. The network 430 can also be wired, such as an Ethernet network, or can be wireless such as a cellular network including EDGE®, 3G and 4G wireless cellular systems. The wireless network can also be WiFi, Bluetooth, or any other wireless form of communication that is known.

The process optimizer 410 further includes a display controller 608, such as a NVIDIA® GeForce GTX® or Quadro® graphics adaptor from NVIDIA® Corporation of America for interfacing with display 610, such as a Hewlett Packard® HPL2445w LCD monitor. A general purpose I/O interface 612 interfaces with a keyboard and/or mouse 614 as well as a touch screen panel 616 on or separate from display 610. General purpose I/O interface also connects to a variety of peripherals 618 including printers and scanners, such as an OfficeJet® or DeskJet® from Hewlett Packard®.

A sound controller 620 is also provided in the process optimizer 410, such as Sound Blaster X-Fi Titanium® from Creative®, to interface with speakers/microphone 622 thereby providing sounds and/or music.

The general purpose storage controller 624 connects the storage medium disk 604 with communication bus 626, which may be an ISA, EISA, VESA, PCI, or similar, for interconnecting all of the components of the process optimizer 410. A description of the general features and functionality of the display 610, keyboard and/or mouse 614, as well as the display controller 608, storage controller 624, network controller 606, sound controller 620, and general purpose I/O interface 612 is omitted herein for brevity as these features are known.

The above-described hardware description is a non-limiting example of corresponding structure for performing the functionality described herein.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. A system to support business performance, comprising:
a computer with one or more processors;
a business intelligence server running on the computer, wherein the business intelligence server operates to take inputs from different data sources;
a scorecard application associated with the business intelligence server; and
a process improvement application associated with the business intelligence server, wherein the business intelligence server operates to
define an internal data structure that holds a plurality of strategy components and one or more key performance indicators,
populate each strategy component in the internal data structure based on the inputs from the different data sources,
analyze the one or more key performance indicators via the process improvement application to identify strategic and key internal processes requirements, and
output the identified strategic and key internal processes requirements to the scorecard application.

2. The system according to claim 1, wherein the scorecard application is a balanced scorecard application.

3. The system according to claim 1, wherein the process improvement application is a six sigma supplier, input, process, output, customer application (SIPOC).

4. The system according to claim 1, wherein the plurality of strategy components are associated with one or more metrics that are quantifiable performance statements.

5. The system according to claim 1, further comprising:
a causes and effects relationship map that includes one or more cause and effect linkages among one or more nodes.

6. The system according to claim 2, wherein the BSC application includes a financial perspective, a customer perspective, an internal business processes perspective, and a learning and growth perspective.

7. A method, comprising:
associating a scorecard application with a business intelligence server that operates to take from different data sources;
associating a process improvement application with the business intelligence server; and
allowing the scorecard application and the process improvement application associated with the business intelligence server to
define an internal data structure that holds a plurality of strategy components and one or more key performance indicators,
populate each strategy component in the internal data structure based on the inputs from the different data sources,
analyze the one or more key performance indicators via the process improvement application to identify strategic and key processes requirements from the plurality of strategy contained in the internal data structure,
performing a process improvement application on the strategic and key internal processes requirements
and
output the identified strategic and key internal processes requirements to the scorecard application.

8. The method according to claim 7, wherein the scorecard application is a balanced scorecard application.

9. The method according to claim 7, wherein the process improvement application is a six sigma supplier, input, process, output, customer (SIPOC) application.

10. The method according to claim 7, wherein the plurality of strategy components are associated with one or more metrics that are quantifiable performance statements.

11. The method according to claim 7, further comprising:
a causes and effects relationship map that includes one or more cause and effect linkages among one or more nodes.

12. The method according to claim 8, wherein the balanced scorecard application includes a financial perspective, a customer perspective, an internal business processes perspective, and a learning and growth perspective.

13. A non-transitory computer-readable medium having instructions stored thereon that when executed in hardware, cause a system to:
associate a scorecard application with a business intelligence server that operates to take from different data sources;
associate a process improvement application with the business intelligence server; and
allow the scorecard application and the process improvement application associated with the business intelligence server to
define an internal data structure that holds a plurality of strategy components and one or more key performance indicators,
populate each strategy component in the internal data structure based on the inputs from the different data sources,
analyze the one or more key performance indicators via the process improvement application to identify strategic and key internal processes requirements, and
output the identified strategic and key internal processes requirements to the scorecard application.
